(19) United States
(12) Patent Application Publication
(10) Pub. No.: US 2026/0249796 A1
(43) Pub. Date: Aug. 27, 2026

(54) VEHICLE

(71) Applicants: TOYOTA JIDOSHA KABUSHIKI KAISHA, Toyota-shi (JP); SUBARU CORPORATION

(72) Inventor: Kenji TAKAHASHI, Shibuya-ku (JP)

(73) Assignees: TOYOTA JIDOSHA KABUSHIKI KAISHA, Toyota-shi (JP); SUBARU CORPORATION, Tokyo (JP)

(21) Appl. No.: 19/547,632

(22) Filed: Feb. 23, 2026

(30) Foreign Application Priority Data
Feb. 25, 2025 (JP) 2025-028295

(51) Int. Cl. B60R 19/12; B60K 11/08

(52) U.S. Cl. CPC B60R 19/12; B60K 11/08

(57) ABSTRACT

A vehicle includes: a bumper reinforcement that is located at a front end portion of the vehicle and extends in the left-right direction of the vehicle; a lower reinforcement that is located below the bumper reinforcement and extends in the left-right direction of the vehicle; a bumper cover that covers the bumper reinforcement and the lower reinforcement from the front; and a guide member provided on the lower reinforcement. The guide member includes a guide surface interposed between a front surface of the lower reinforcement and the bumper cover. The guide surface faces the bumper cover from the rear and slopes downward toward the front.

### CROSS-REFERENCE TO RELATED APPLICATION

This application claims priority to Japanese Patent Application No. 2025-028295 filed on Feb. 25, 2025. The disclosure of the above-identified application, including the specification, drawings, and claims, is incorporated by reference herein in its entirety.

### BACKGROUND

### 1. Technical Field

The technology disclosed in the present specification relates to vehicles, and more particularly to the structure of a front bumper.

### 2. Description of Related Art

Japanese Unexamined Patent Application Publication No. 2007-145159 (JP 2007-145159 A) discloses a vehicle. The vehicle body includes a bumper reinforcement that extends in the left-right direction of the vehicle at the front end of the vehicle, a bumper cover that covers the bumper reinforcement from the front, and a cushioning member disposed between the bumper reinforcement and the bumper cover.

### SUMMARY

In a vehicle, a lower reinforcement may be mounted below the bumper reinforcement. The front bumper may be provided with an air intake opening for introducing traveling air. In this case, the air intake opening is located between the bumper reinforcement and the lower reinforcement located below it. In such a configuration, when the air intake opening is designed relatively large, for example, for styling reasons, a lower edge portion of the bumper cover that defines the air intake opening faces the front surface of the lower reinforcement. In the bumper cover, the lower edge portion that defines the air intake opening has relatively high rigidity depending on its shape. Therefore, when the lower edge portion comes into contact with the front surface of the lower reinforcement in the event of, for example, a frontal collision of the vehicle, the bumper cover may not deform enough and may not sufficiently absorb impact energy. In other words, in order to address such an issue, it would be necessary to impose design restrictions on the air intake opening.

The above-described issue occurs regardless of whether an air intake opening is provided. In addition to the lower edge portion that defines the air intake opening, the bumper cover may, depending on its design, have a relatively rigid portion that faces the front surface of the lower reinforcement. In such a case, the same issue can occur.

In view of the foregoing, the present specification provides a technique that can achieve both design flexibility of the bumper cover and impact energy absorption performance of the bumper cover in a vehicle.

The technology disclosed in the present specification is embodied in a vehicle. The vehicle includes: a bumper reinforcement that is located at a front end portion of the vehicle and extends in the left-right direction of the vehicle; a lower reinforcement that is located below the bumper reinforcement and extends in the left-right direction of the vehicle; a bumper cover that covers the bumper reinforcement and the lower reinforcement from the front; and a guide member provided on the lower reinforcement. The guide member includes a guide surface interposed between a front surface of the lower reinforcement and the bumper cover. The guide surface faces the bumper cover from the rear and slopes downward toward the front.

With this configuration, when a frontal collision of the vehicle occurs, the bumper cover moves rearward and comes into contact with the guide surface of the guide member. The guide surface is inclined downward toward the front. Therefore, the bumper cover that comes into contact with the guide surface is guided upward and rearward along the guide surface. Accordingly, even when, for example, an air intake opening is designed relatively large and a lower edge portion that defines the air intake opening of the front bumper is positioned to face the front surface of the lower reinforcement, the lower edge portion can be kept out of contact with the front surface of the lower reinforcement in the event of a frontal collision of the vehicle. In other words, deformation of the bumper cover is not suppressed, allowing the bumper cover to sufficiently absorb impact energy.

In one embodiment of the present technology, the bumper cover may include a guided surface that faces the guide surface of the guide member from the front. The guided surface of the bumper cover may slope upward toward the rear. With this configuration, when a frontal collision of the vehicle occurs, the guided surface of the bumper cover comes into contact with the guide surface of the guide member. Since the guided surface of the bumper cover is inclined upward toward the rear, the bumper cover that moves toward the lower reinforcement can be more smoothly guided upward and rearward along the guide surface.

In the above embodiment, the bumper cover may have an air intake opening positioned to face a gap between the bumper reinforcement and the lower reinforcement. The guided surface of the bumper cover may be provided along a lower edge of the air intake opening. With this configuration, even when the lower edge portion of the air intake opening is positioned to face the front surface of the lower reinforcement, the bumper cover that moves toward the lower reinforcement can be more smoothly guided upward and rearward along the guide surface. As a result, the air intake opening can be designed larger, thereby further improving the design flexibility of the front bumper.

In one embodiment of the present technology, an upper end portion of the guide surface may extend to a position adjacent to the upper edge of the front surface of the lower reinforcement. With this configuration, when a frontal collision of the vehicle occurs, the bumper cover that comes into contact with the guide surface can be more reliably kept out of contact with the front surface of the lower reinforcement. As a result, the impact energy absorption performance of the front bumper can further be improved.

In one embodiment of the present technology, a lower end portion of the guide surface may extend to a position where the lower end portion contacts the bumper cover. With this configuration, the bumper cover is also supported by the lower reinforcement via the guide member, and the bumper cover can be stably held in position.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view showing a front end portion 10 of a vehicle 2 according to an embodiment;

FIG. 2 is a cross-sectional view of the front end portion 10 taken along line II-II in FIG. 1; and

FIG. 3 is a plan view taken along line III-III in FIG. 2.

### DETAILED DESCRIPTION OF EMBODIMENTS

A vehicle 2 according to an embodiment will be described with reference to the drawings. The vehicle 2 is an automobile that travels on a road. The vehicle 2 may be, for example, an engine-powered vehicle, a hybrid electric vehicle, a fuel cell electric vehicle, a battery electric vehicle, or a solar-powered vehicle. The vehicle 2 is not limited to a vehicle operated by a user, and may be a vehicle that is remotely controlled by an external device or capable of autonomous driving.

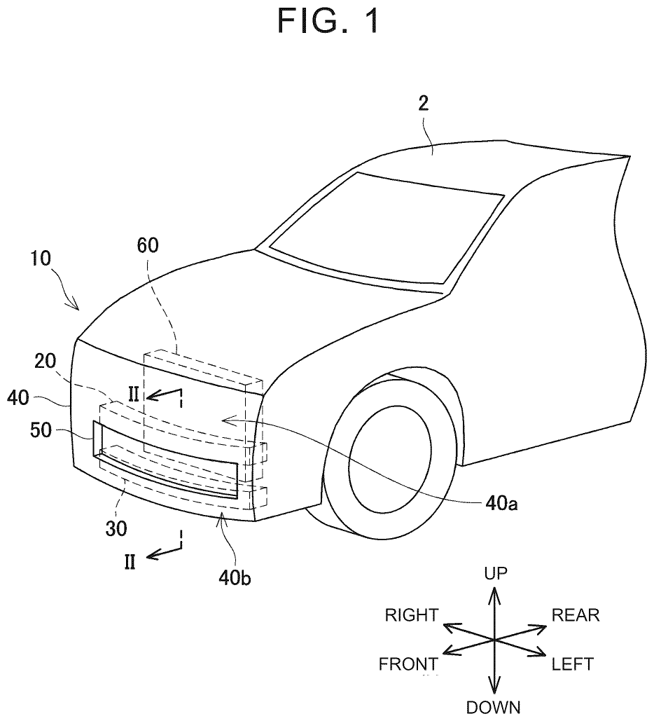

FIG. 1 is a perspective view of a front end portion 10 of the vehicle 2. In FIGS. 1 to 3, the front-rear, up-down, and left-right directions correspond to the front-rear, up-down, and left-right directions of the vehicle 2, respectively, and are perpendicular to each other.

The front end portion 10 of the vehicle 2 includes a bumper reinforcement 20, a lower reinforcement 30, a bumper cover 40, and a radiator 60. The bumper reinforcement 20 and the lower reinforcement 30 are made of metal. The bumper reinforcement 20 and the lower reinforcement 30 may alternatively be made of a material other than metal. The bumper reinforcement 20 is located at the front end portion 10 of the vehicle 2 and extends in the left-right direction of the vehicle 2. The lower reinforcement 30 is located below the bumper reinforcement 20 and extends in the left-right direction of the vehicle 2. The bumper cover 40 is made of resin. The bumper cover 40 may alternatively be made of another material such as a carbon fiber-reinforced resin. The bumper cover 40 covers the bumper reinforcement 20 and the lower reinforcement 30 from the front.

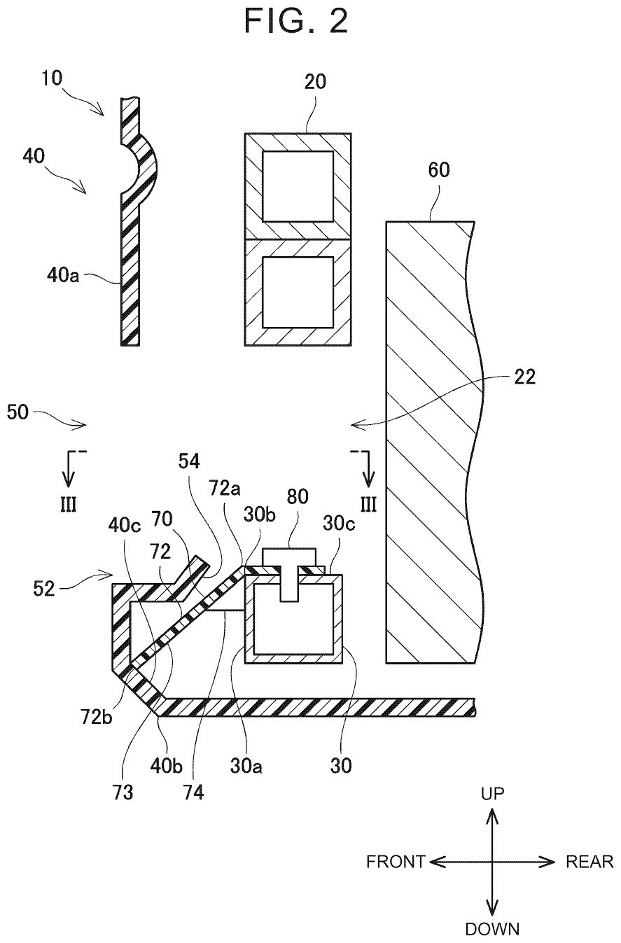

The bumper cover 40 has an air intake opening 50. The bumper cover 40 can be divided into an upper portion 40a and a lower portion 40b with the air intake opening 50 serving as a boundary. As shown in FIG. 2, the air intake opening 50 is positioned so as to face a gap 22 between the bumper reinforcement 20 and the lower reinforcement 30 in the up-down direction. The radiator 60 is connected to a cooling pipe (not shown) through which coolant circulates, and is configured to exchange heat with a drive unit (not shown) by circulating the cooling water between the radiator 60 and the drive unit. This allows the radiator 60 to cool the drive unit. The specific configuration of the drive unit is not particularly limited. The drive unit may be, for example, a prime mover including an internal combustion engine, or an electric motor.

As shown in FIG. 2, a guide member 70 is disposed in front of the lower reinforcement 30. The guide member 70 is fastened to an upper surface 30c of the lower reinforcement 30 by a plurality of bolts 80. The method for fixing the guide member 70 to the lower reinforcement 30 is not particularly limited. The guide member 70 has a guide surface 72. The guide surface 72 is interposed between a front surface 30a of the lower reinforcement 30 and the lower portion 40b of the bumper cover 40. The guide surface 72 faces the lower portion 40b of the bumper cover 40 from the rear and slopes downward toward the front. With this configuration, when a frontal collision of the vehicle 2 occurs, the bumper cover 40 moves rearward and comes into contact with the guide surface 72 of the guide member 70. Since the guide surface 72 is inclined downward toward the front, the bumper cover 40 that comes into contact with the guide surface 72 is guided upward and rearward along the guide surface 72. Accordingly, even when, as in the present embodiment, the air intake opening 50 is designed relatively large and a lower edge 52 that defines the air intake opening 50 of the bumper cover 40 is positioned to face the front surface 30a of the lower reinforcement 30, the lower edge 52 can be kept out of contact with the front surface 30a of the lower reinforcement 30 in the event of a frontal collision of the vehicle 2. In other words, deformation of the bumper cover 40 is not suppressed, allowing the bumper cover 40 to sufficiently absorb impact energy.

An upper end portion 72a of the guide surface 72 of the guide member 70 extends to a position adjacent to an upper edge 30b of the front surface 30a of the lower reinforcement 30. With this configuration, when a frontal collision of the vehicle 2 occurs, the bumper cover 40 that comes into contact with the guide surface 72 can be more reliably kept out of contact with the front surface 30a of the lower reinforcement 30. As a result, the impact energy absorption performance of the bumper cover 40 can further be improved. In another embodiment, the upper end portion 72a of the guide surface 72 may not extend to the upper edge 30b of the front surface 30a of the lower reinforcement 30.

A lower end portion 72b of the guide surface 72 of the guide member 70 extends to a position where it contacts an inner surface 40c of the lower portion 40b of the bumper cover 40. With this configuration, the bumper cover 40 is also supported by the lower reinforcement 30 via the guide member 70, and the bumper cover 40 can be stably held in position. In another embodiment, the lower end portion 72b of the guide surface 72 may not be in contact with the inner surface 40c of the lower portion 40b of the bumper cover 40.

The bumper cover 40 has a guided surface 54. The guided surface 54 extends in the right-left direction along the lower edge 52 of the air intake opening 50. The guided surface 54 faces the guide surface 72 of the guide member 70 from the front. The guided surface 54 slopes upward toward the rear. With this configuration, when a frontal collision of the vehicle 2 occurs, the guided surface 54 of the bumper cover 40 comes into contact with the guide surface 72 of the guide member 70. Since the guided surface 54 of the bumper cover 40 is inclined upward toward the rear, the bumper cover 40 that moves toward the lower reinforcement 30 can be more smoothly guided upward and rearward along the guide surface 72.

In particular, the guided surface 54 of the bumper cover 40 is provided along the lower edge 52 of the air intake opening 50. With this configuration, even when the air intake opening 50 is designed large and the lower edge 52 of the air intake opening 50 is positioned to face the front surface 30a of the lower reinforcement 30, the bumper cover 40 that moves toward the lower reinforcement 30 can be more smoothly guided upward and rearward along the guide surface 72. As a result, the air intake opening 50 can be designed larger, thereby further improving the design flexibility of the bumper cover 40. In another embodiment, the guided surface 54 may be provided at a position spaced apart from the lower edge 52 of the air intake opening 50.

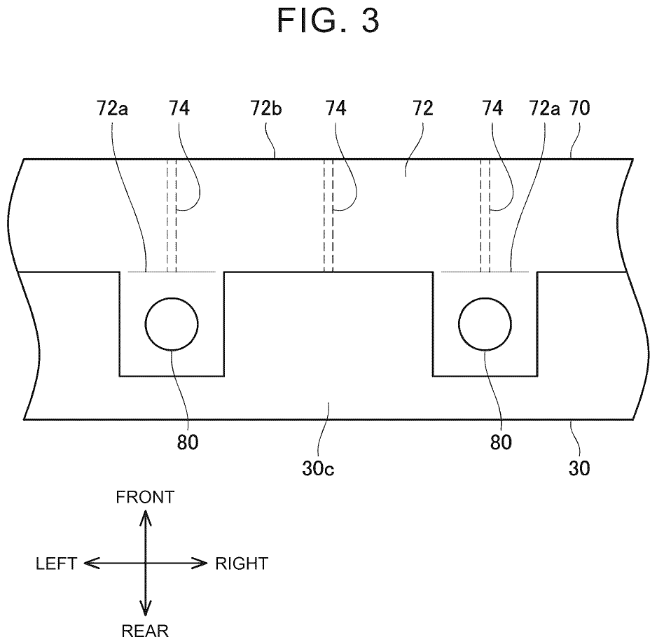

As shown in FIGS. 2 and 3, the guide member 70 has a plurality of braces 74 on a rear surface 73 opposite the guide surface 72. The braces 74 are arranged in the left-right direction at regular intervals along the front surface 30a of the lower reinforcement 30. With this configuration, when a frontal collision of the vehicle 2 occurs, the braces 74 can receive a load applied from the bumper cover 40 that comes into contact with the guide surface 72. This configuration can improve the rigidity of the guide member 70.

While specific examples of the technology disclosed in the present specification have been described in detail above, these are merely illustrative and do not limit the scope of the claims. The technology described in the claims includes modifications and variations of the examples illustrated above. The technical elements described in the present specification or illustrated in the drawings may exhibit technical utility alone or in various combinations, and are not limited to the combinations described in the claims as filed. The technology illustrated in the present specification or drawings can achieve multiple objectives simultaneously, and has technical utility even when one of those objectives is achieved.

What is claimed is:

1. A vehicle comprising:
a bumper reinforcement that is located at a front end portion of the vehicle and extends in a left-right direction of the vehicle;
a lower reinforcement that is located below the bumper reinforcement and extends in the left-right direction of the vehicle;
a bumper cover that covers the bumper reinforcement and the lower reinforcement from front; and
a guide member provided on the lower reinforcement, wherein:
the guide member includes a guide surface interposed between a front surface of the lower reinforcement and the bumper cover; and
the guide surface faces the bumper cover from rear and slopes downward toward the front.

2. The vehicle according to claim 1, wherein:
the bumper cover includes a guided surface that faces the guide surface of the guide member from the front; and
the guided surface of the bumper cover slopes upward toward the rear.

3. The vehicle according to claim 2, wherein:
the bumper cover has an air intake opening positioned to face a gap between the bumper reinforcement and the lower reinforcement; and
the guided surface of the bumper cover is provided along a lower edge of the air intake opening.

4. The vehicle according to claim 1, wherein an upper end portion of the guide surface extends to a position adjacent to an upper edge of the front surface of the lower reinforcement.

5. The vehicle according to claim 1, wherein a lower end portion of the guide surface extends to a position where the lower end portion contacts the bumper cover.
